(19) United States
(12) Patent Application Publication
(10) Pub. No.: US 2016/0117161 A1
(43) Pub. Date: Apr. 28, 2016

(54) INSTALLING AND UPDATING SOFTWARE SYSTEMS

(71) Applicant: Microsoft Corporation, Redmond, WA (US)

(72) Inventors: Srivatsan Parthasarathy, Seattle, WA (US); Jeffrey Scott Zabel, Redmond, WA (US); Mohanish Rajesh Penta, Bellevue, WA (US); Kiran Isaac Abraham, Redmond, WA (US); Spencer James Clark, Redmond, WA (US); Haojie Hang, Bellevue, WA (US); Mokhtar M. Khorshid, Redmond, WA (US); Filippo Seracini, Bellevue, WA (US); Justin R. Incarnato, Forth Worth, TX (US)

(21) Appl. No.: 14/525,179

(22) Filed: Oct. 27, 2014

(51) Int. Cl. G06F 9/445; H04L 29/08

(52) U.S. Cl. CPC G06F 8/65; H04L 67/06

(57) ABSTRACT

The present invention extends to methods, systems, and computer program products for installing and updating software systems. Aspects of the invention include selecting software update packages that automatically installs essentially any number of code changes for any number of software components to update a software system (e.g., a cloud appliance). In one aspect, a software system is updated by implementing a software update package that includes: references to code changes for a plurality of software components and references to installation artifacts for installing the code changes, and also indicates interdependencies between the plurality of software components. In another aspect, validation code is used to validate that a software update package transitioned a software system to a goal state. In a further aspect, a multi-pass installation process is orchestrated to perform portions of a software update package in a plurality of different passes.

### CROSS-REFERENCE TO RELATED APPLICATIONS

Not Applicable

### BACKGROUND

### 1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

To perform computing tasks, computer systems run software. For example, to provide word processing functionality a computer system runs word processing software (an application). Software is continually evolving to include updated functionality, for example, to correct bugs, address security issues, add features, etc. From time to time, a software developer can release updates to their software that include updated functionality. Computer system users can install updates at their computer system to add updated functionality to their software.

In a standalone computing environment (e.g., on a home users desktop computer) installing updates is a relatively straight forward process. Many applications and operating systems have built in updaters (other software) that use network (e.g., Internet) connectivity to determine when an update is available. Some updaters automatically alert users (e.g., through a user-interface) when updates are available. Other updaters at least permit users to check for updates when they desire. When an update is available, the user can select the update and the updater automatically installs the update for the user.

In cloud computing environments, applications and operating systems are run in distributed and/or networked environments, such as, for example, in public and private clouds. Within a cloud computing environment, hardware can be configured as virtual machines (“VMs”). VMs can be allocated for different functions, such as, management, compute, storage, and networking. Management VMs can include a variety of different interoperating management software applications that provide management functionality to a client or customer. Management functionality can include configuring, deploying, monitoring, and updating of management VMs, compute VMs, storage VMs, and networking VMs.

Different development groups can own and have responsibly for maintaining different management software applications. As such, the timing of releasing updates for different management software applications can vary. Some development groups can release updates on a schedule and others can release updates on an ad hoc basis. Even when updates are released on a schedule, different development groups can have different schedules. Thus, at any given time, some different number and variety of management software application updates may be available for management VMs running in a cloud computing environment.

Updates in cloud computing environments, can also be performed manually. An administrator can identify a number of updates to install, manually formulate an installation plan (e.g., how to take down and bring up systems, determine a specified order for installing updates, etc.), and then install updates in accordance with the installation plan (e.g., take down and bring up systems, install updates in the specified order, etc.). However, since management software applications have to interoperate but are often developed by different groups, updates to one management software application can cause another management software application to operate in an unintended manner. Unintended operation can be caused by one development group not being aware of requirements for another development group's application, problems with an administrator's installation plan, etc.

In some cloud computing environments, software and hardware are owned by (or at least under control of) the same entity. For example, a software company may have a private cloud for employees. The private cloud can include various hardware components that run software, including various and different interpolating management software applications, developed by the software company. In these cloud computing environments, technicians and engineers have full access (both physically and virtually) to hardware and software. Having full access to hardware and software makes it somewhat easier for technicians and engineers to identify and address operational problems at management VMs.

In other cloud computing environments, software is developed by one entity and is run on hardware managed and controlled by a variety of other different entities. For example, a software company can develop management software for managing VMs in a cloud computing environment. The management software can include many different interoperating management software applications. A variety of other 3^{rd} parties (e.g., other companies) can purchase and run some or all of the different interoperating software applications to manage VMs run on hardware under their control. Some of 3^{rd} parties may use the management software to manage VMs in a private cloud used only by the company. Other of the 3^{rd} parties may use the management software to manage VMs that are resold to external customers. In some environments, a 3^{rd} party runs a complex, multi-node private cloud appliance, which delivers Infrastructure as a Service (“IaaS”) services to multiple tenants.

Updating management software applications in these other cloud computing environments is typically also performed manually by an administrator. However, identifying and addressing operational problems at management VMs can be much more difficult in these other cloud computing environments. For example, different 3^{rd} parties can have different combinations of management software applications installed on their hardware. Different 3^{rd} parties can also have different combinations of updates, and possibly also additional fixes installed (3^{rd} parties may desire to update at their own pace). Thus, even if 3^{rd} parties have the same management software applications installed, the management software applications can be at different updates and may have different fixes installed.

Based on the number of management software applications and the number of updates and applied fixes for each management software application, a very large number of different combinations are possible. Each different combination of management software applications and updates, and possibly also fixes, can result in different operational problems. The sheer number of combinations can make it more difficult for technicians and engineers of the software developer to identify and address management software operational problems at 3rd parties' management VMs. For example, it may be difficult to even identify a prior functioning state for the management VMs.

Further, a 3^{rd} party may limit access (physical and/or virtual) to their software, hardware, and operational data (e.g., logs). For example, a 3^{rd} pay may no network (e.g., Internet) connectivity. Limited access can be due to requirements of a 3^{rd} party or of the 3^{rd} party's customers. For example, if a healthcare provider is a customer of a 3^{rd} party cloud provider, the healthcare provider may limit those with access to patient healthcare data. Having limited access to one or more of: software, hardware, and data further increases difficulty for technicians and engineers when attempting to identify and address management software operational problems at 3rd parties' management VMs.

Additionally, 3^{rd} may require that updates be performed in a manner that does not violate designated Service Level Agreements (“SLAs”). There can be one SLA between a management software application provider and the 3^{rd} party. This SLA can specify the maximum downtime a management head can incur. There can be another SLA between the 3^{rd} party and its customers. This other SLA specifies the maximum downtime a customer will face for his assets, Thus, any updates, as well as any necessary troubleshooting, cannot take down a 3^{rd} party's management VMs for any significant amount of time without incurring costs under one or both SLAs. Installing software updates in a manner that does not violate customer SLAs increases installation complexity.

### BRIEF SUMMARY

The present invention extends to methods, systems, and computer program products for installing and updating software systems. Various different development groups manage the development of code for a plurality of corresponding (and possibly interoperating) software components (e.g., applications, operating system, etc.) of a software system (e.g., a cloud appliance). Each different development group can release code changes (e.g., updates and/or fixes) for their corresponding software component(s) at different and varied times. The code changes can be combined in software update packages, permitting a number of code changes for different software components to be installed automatically.

Aspects of the invention include selecting software update packages that automatically install essentially any number of code changes for any number of software components to update a software system (e.g., a cloud appliance). In one aspect, a software system is updated by implementing a software update package that includes: references to code changes for a plurality of software components and references to installation artifacts for installing the code changes, and also indicates interdependencies between the plurality of software components. In another aspect, validation code is used to validate that a software update package transitioned a software system to a goal state. In a further aspect, a multi-pass installation process is orchestrated to perform portions of a software update package in a plurality of different passes.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific implementations thereof which are illustrated in the appended drawings. Understanding that these drawings depict only some implementations of the invention and are not therefore to be considered to be limiting of its scope, the invention will be described and explained with additional specificity and detail through the use of the accompanying drawings in which:

FIG. 1A illustrates an example computer architecture illustrating software changes being released by development groups.

FIG. 1B illustrates an example computer architecture depicting a data flow for updating cloud appliances.

FIG. 2 illustrates an example computer architecture that facilitates creating software installation packages and software update packages.

FIG. 3 illustrates an example of timing for different customers installing software updates.

FIG. 4 illustrates an example computer architecture that facilitates updating a software system.

FIG. 5 illustrates a flow chart of an example method for updating a software system.

FIG. 6 illustrates an example computer architecture that facilitates updating a software system.

FIG. 7 illustrates a flow chart of an example method for updating a software system.

FIG. 8 illustrates an example computer architecture that facilitates updating a software system.

FIG. 9 illustrates a flow chart of an example method for updating a software system.

FIG. 10 illustrates an example of processing a manifest to create a multi-pass installation plan.

FIG. 11 illustrates a flow chart of an example method of updating an individual software component

FIG. 12 illustrates an example computer architecture that facilitates creating a software update package.

FIG. 13 illustrates an example of a Bill of Materials (BOM) for a software update package.

FIG. 14 illustrates an example computer architecture that facilitates creating a software update package for linear progression between validated goal states.

FIG. 15 illustrates an example computer architecture that facilitates creating a software update package for use in a multi-pass installation.

### DETAILED DESCRIPTION

The present invention extends to methods, systems, and computer program products for installing and updating software systems. Various different development groups manage the development of code for a plurality of corresponding (and possibly interoperating) software components (e.g., applications, operating system, etc.) of a software system (e.g., a cloud appliance). Each different development group can release code changes (e.g., updates and/or fixes) for their corresponding software component(s) at different and varied times. The code changes can be combined in software update packages, permitting a number of code changes for different software components to be installed automatically.

Aspects of the invention include selecting software update packages that automatically install essentially any number of code changes for any number of software components to update a software system (e.g., a cloud appliance). In one aspect, a software system is updated by implementing a software update package that includes: references to code changes for a plurality of software components and references to installation artifacts for installing the code changes, and also indicates interdependencies between the plurality of software components. In another aspect, validation code is used to validate that a software update package transitioned a software system to a goal state. In a further aspect, a multi-pass installation process is orchestrated to perform portions of a software update package in a plurality of different passes.

Implementations of the present invention may comprise or utilize a special purpose or general-purpose computer including computer hardware, such as, for example, one or more processors and system memory, as discussed in greater detail below. Implementations within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, wearable devices, multi-processor systems, microprocessor-based or programmable consumer electronics, network PCs, minicomputers, mainframe computers, mobile telephones, PDAs, tablets, pagers, watches, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The invention can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the claims, a “cloud computing environment” is an environment in which cloud computing is employed.

In this description and the following claims, a “cloud appliance” is defined as a computer system (e.g., commodity hardware) running one or more (e.g., pre-configured) software components. In some aspects, a cloud appliance is a computer system with a virtual machine (VM) image installed. The virtual machine image file can include one or more (pre)configured software components.

In some aspects, a plurality of development groups maintains code for a plurality at different software components included in a cloud appliance. To maintain a software component, a development group can release changes to the software component. Different development groups can release changes to their software components at different and varied times.

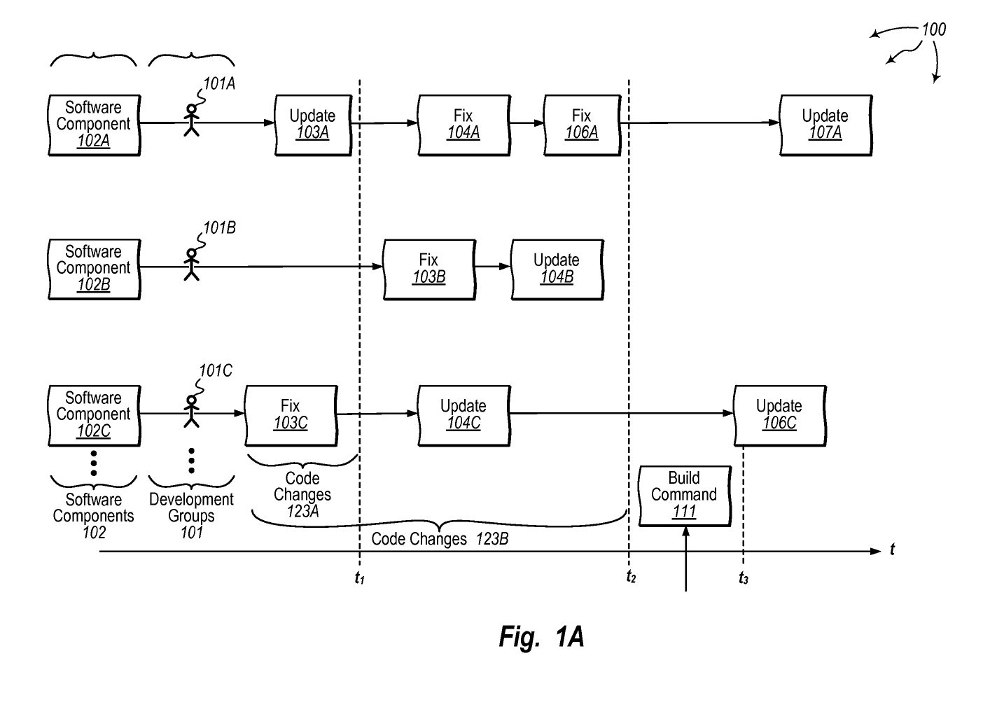

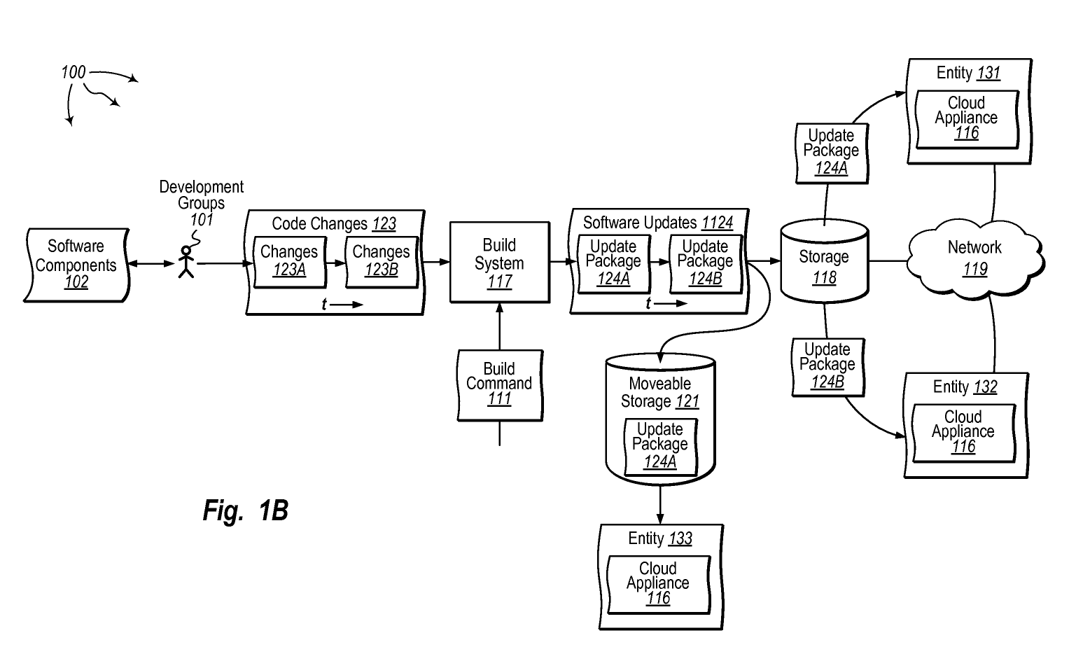

FIG. 1A illustrates an example computer architecture 100 illustrating software changes (e.g., updates and/or fixes) being released by development groups. As depicted, development groups 101 include development groups 101A, 101B, 101C, etc. Software components 102 include software components 120A, 102B, and 102C. Each of development groups 101A, 101B, 101C, etc. can be responsible for one or more of: developing, maintaining, and updating a software component that is run on software systems (e.g., cloud appliances). For example, development group 101A can be responsible for software component 102A, development group 101B can be responsible for software component 102B, development group 101C can be responsible for software component 102C, etc.

In FIG. 1A, time progresses from left (earlier in time) to right (later in time). Thus, over time, development group 101A releases various changes to software component 102A, including update 103A, followed by fix 104A, followed by fix 106A, followed by update 107A to. Similarly, over time, development group 101B releases various changes to software component 102B, including fix 103B, followed by update 104B. Likewise, over time, development group 101C releases various changes to software component 102C, including fix 103C, followed by update 104C, followed by update 106C.

As such, at any given time, a variety of different combinations of changes may be available for different software components. At time t₁, update 103A and fix 103C are available (and can be viewed collectively as code changes 123A). Later at time t₂, update 103A, fix 104A, fix 106A, fix 103B, update 104B, fix 103C, and update 104C are available (and can be viewed collectively as code changes 123B). As time progresses, other updates and/or fixes may become available.

At some time between t₂ and t₃, build command 111 can be issued. Build command 111 can be a manual or automated command to build a new software update package.

FIG. 1B illustrates other components of computer architecture 100 depicting a general data flow for updating cloud appliances. Within computer architecture 100, instances of cloud appliance 106 can include software components 102. Development groups 101 can release code changes 123 (e.g., code changes 123A, 123B, etc.) for software components 102 over time. From time to time, for example, on a schedule or in response to an entity request, build system 117 can receive build command 111. In response to build command 111, build system 117 can build a software update 124 (e.g., updates 124A, 124B, etc.). Build system 117 can store software updates at storage 118. Entities can access updates stored at storage 118 via network 119 (e.g., the Internet). For example, entity 131 can access update 124A from storage 118 to update cloud appliance 116 (to one state). Similarly, entity 132 can access update 124B from storage 118 to update cloud appliance 116 (to another later state).

Entity 133, for security and/or privacy reasons, may prefer to keep deployed cloud appliances disconnected from public networks (e.g., the Internet). Build system 117 can also store any of software updates 124, for example, update 124A, into a self-contained package on movable storage 121 (e.g., a thumb drive, DVD, CD, etc.) The movable drive can be provided to the entity 133 and entity 133 can use the self-contained package to update cloud appliance 116.

In one aspect, a build system generates a corresponding software installation package along with a software update package in response to a build command. The software installation package can be used to install instances of cloud appliance on hardware. The software update package can be used update instances of cloud appliance that are already installed on hardware. Both the software installation package and the software update package are configured to bring a cloud appliance to the same goal state.

In another aspect, intermediate staging servers and/or build servers can be used to stage code changes or build an update/fix for an individual software component. Code can be staged and updates/fixes built for individual software components between more complex installation/update builds for a cloud appliance.

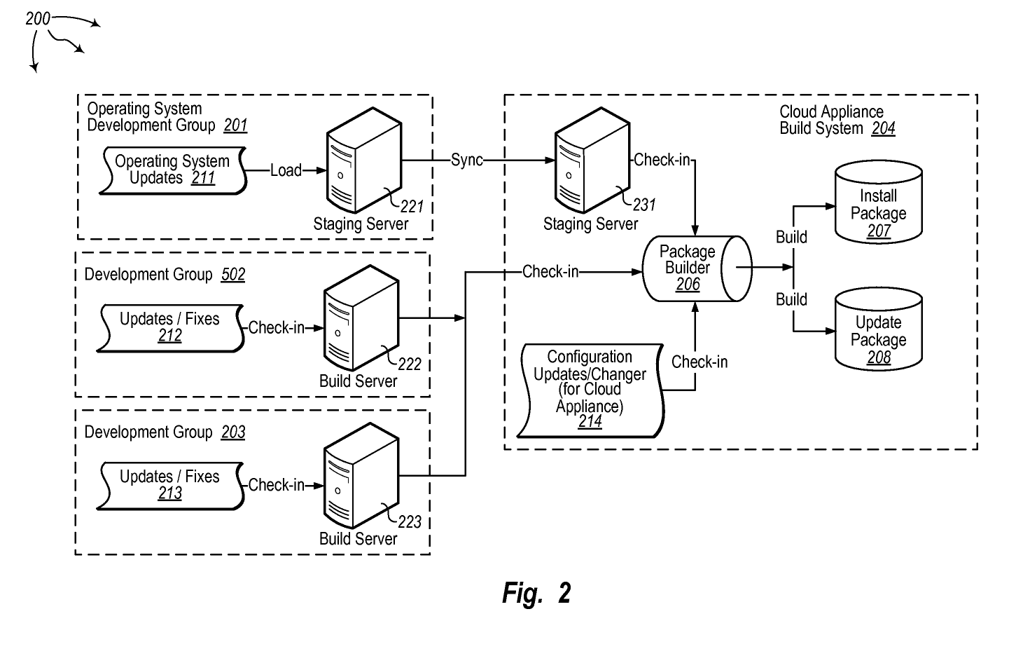

FIG. 2 illustrates an example computer architecture 200 that facilitates creating software installation packages and software update packages. As depicted, operating system development group 201, development group 202, and development group 203 can submit updates/fixes to cloud appliance build system 204. Operating system updates 211 can be loaded to staging server 221. Updates/fixes 212 can be checked-in to build server 222. Update/fixes 213 can be checked-in to build server 223.

Operating system updates 211 can be synced to staging server 231. From staging server 231, operating system updates 211 can be checked-in with package builder 206. Similarly, updates/fixes 212 and update/fixes 213 can be checked-in with package builder 206 from build servers 222 and 223 respectively. Configuration updates/changes 214 (for a cloud appliance) can also be checked-in with package builder 206. In response to a build command, package builder 206 can build install package 207 and update package 205 for a cloud appliance based on operating system updates 211, updates/fixes 212, update/fixes 213, and configuration updates/changes 214.

In general, a build system can release software update versions in a linear progression and can track the goal state of each software update version. A build system can also consider cumulative impacts of code changes to software components spanning across software update versions (e.g., code changes 123A relative to code changes 123B). When creating a software update version in the linear progression, the build system can determine how to get a cloud appliance from the goal state of any prior software update versions to the goal state of the software update version being built.

As such, each of installation package 207 and update package 208 are configured to bring a cloud appliance to the same goal state. Additionally, update package 208 can be configured to bring a cloud appliance to the same goal state independent of the prior state of the cloud appliance.

For example, a first instance of a cloud appliance may be at a prior state achieved from installing an update package two or more versions prior to update package 208. A second instance of the cloud appliance may be at a different prior state achieved from installing a version of an update package immediately prior to update package 208. Installing update package 208 on either of the first or second instance of the cloud appliance would cause a transition to the goal state for update package 208. As such, customers have increased flexibility to choose when to apply updates.

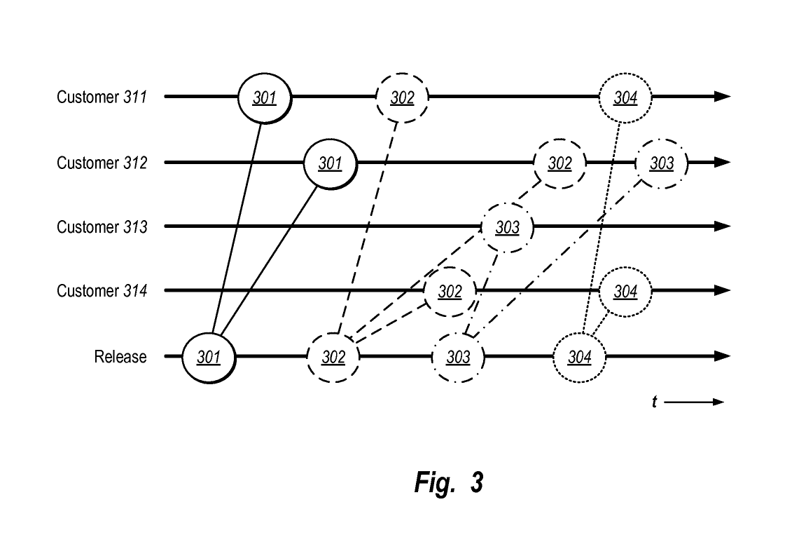

FIG. 3 illustrates an example of timing for different customers installing software updates. In FIG. 3, time progresses from left (earlier in time) to right (later in time). Version 301 is released before version 302. Version 302 is released before version 303. Version 303 is release before version 304. However, as depicted, each customer chooses to update at a different pace and even skip versions.

As depicted, customers 311 and 312 install version 301. Customer 311 updates from version 301 to version 302 prior to the release of version 303. On the other, customer 312 updates from version 301 to version 302 after the release of version 303.

Customer 314 installs version 302. Customer 314 updates from version 302 to version 304 skipping version 303. Similarly, customer 311 updates from version 302 to version 304 skipping version 303. Customer 313 installs version 303 and does not update to version 304. Customer 312 updates from version 302 to version 303 after version 304 is released.

A software update package can have of a variety of different configurations. In one aspect, a software update package includes a bill of materials and a manifest. The bill of materials includes a version and code references. The version is one version in a linear progression of a plurality of software update package versions for updating a cloud appliance. Each version in the linear progression of versions can correspond to a goal state. As such, as a cloud appliance is updated, the cloud appliance can transition from one goal state (corresponding to a prior software update package used to update the cloud appliance) to another goal state (corresponding to the last software update package used to update the cloud appliance). The code references indicate how to access code changes.

The manifest includes references to management artifacts for installing the plurality of code changes and indicates interdependencies between code changes from among the plurality of code changes.

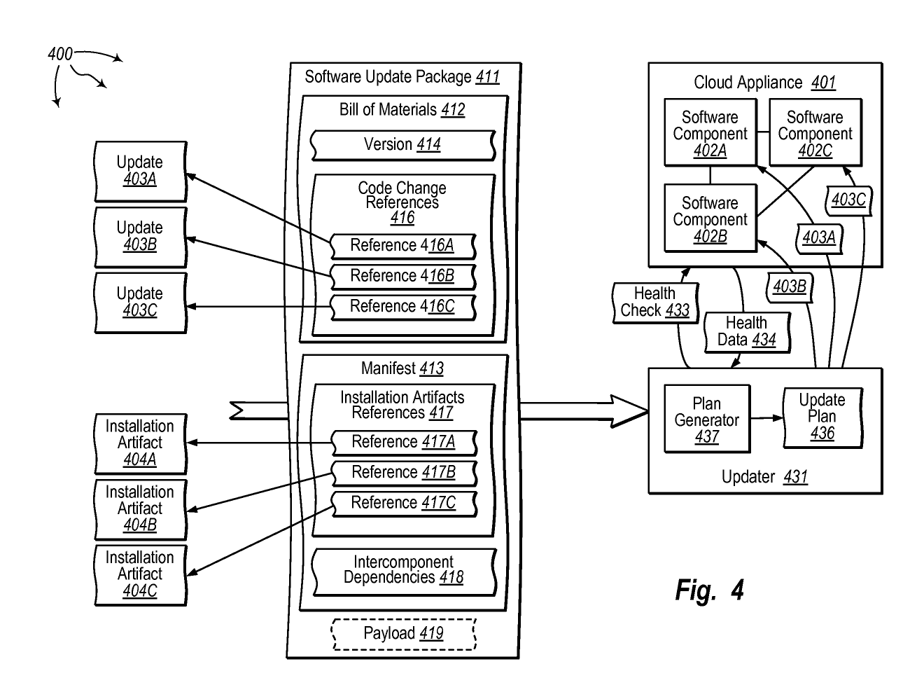

Turning to FIG. 4, FIG. 4 illustrates an example computer architecture 400 that facilitates updating a software system. Referring to FIG. 4, computer architecture 400 includes cloud appliance 401 and updater 431. Cloud appliance 401 and updater 431 can be connected to (or be part of) a network, such as, for example, a Local Area Network (“LAN”), a Wide Area Network (“WAN”), and even the Internet. Accordingly, cloud appliance 401 and updater 431 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

In general, updater 431 is configured to access a software update package and update cloud appliance 401. Updater 431 further includes plan generator 437. Plan generator 437 is configured to generate an update plan based on the contents of a software update package and health data for cloud appliance 401. Updater 401 can then implement the update plan to update cloud appliance 401.

Cloud appliance 401 includes interoperating software components 402A, 402B, and 402C.

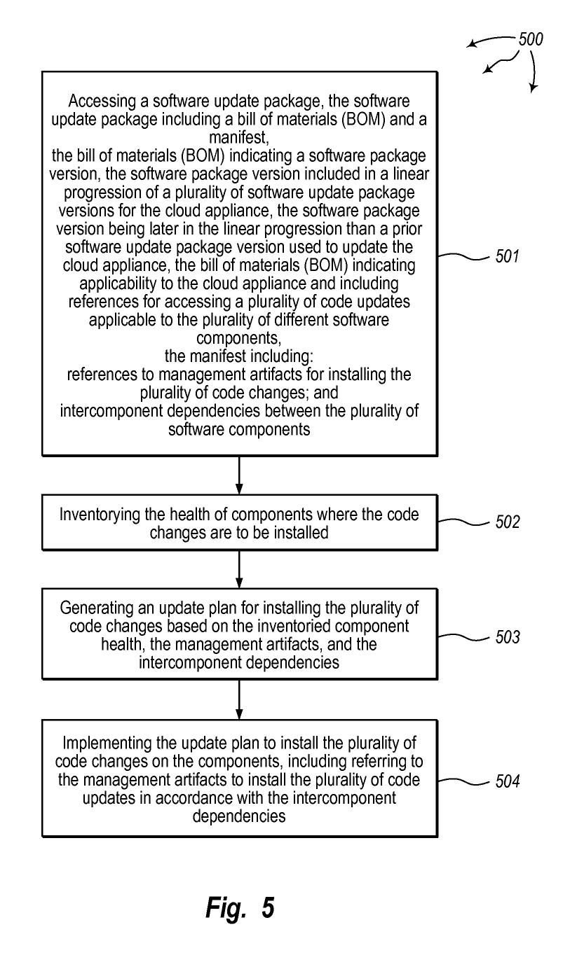

FIG. 5 illustrates a flow chart of an example method 500 for updating a software system. Method 500 will be described with respect to the components and data of computer architecture 400.

Method 500 includes an act of accessing a software update package, the software update package including a bill of materials (BOM) and a manifest (501). The bill of materials (BOM) indicating a software package version, the software package version included in a linear progression of a plurality of software update package versions for the cloud appliance, the software package version being later in the linear progression than the prior software update package version used to update the cloud appliance, the bill of materials (BOM) indicating how to access a plurality of code changes. The manifest including references to management artifacts for installing the plurality of code changes and dependencies between the plurality of code changes.

For example, updater 431 can access software update package 411 including bill of materials (BOM) 412 and manifest 413. Software update package 411 can be accessed from an update directory, an update website, a movable disk, etc. Bill of materials (BOM) 412 includes version 414 and code change references 416. Version 414 can be included in linear progression of plurality of software updates for cloud appliance 401. Version 414 can indicate that software update package 412 is later in a linear progression than the last software update package used to update cloud appliance 401.

Code change references 416 include references 416A, 416B, 416C, etc. indicating how to access update 403A, update 403B, fix 403C, etc. respectively. For example, reference 416A can correspond to a location for update 403A, reference 416B can correspond to a location for fix 403B, reference 416C can correspond to a location for fix 402CA, etc. In one aspect, when an express reference for a code change is not included, an updater 431 can be configured to check an external default location for the code change. In another aspect, when an express reference for a code change is not included, an updater 431 can check a payload 419.

Manifest 413 includes installation artifact references 417 and intercomponent dependencies 418. Each reference in installation artifact references 417 can refer to an installation artifact for a corresponding code change. For example, reference 417A can refer to installation artifact 404A (for update 403A), reference 417B can refer to installation artifact 404B (for update 404B), reference 417C can refer to installation artifact 404C (for fix 106A), reference 217D can refer to an installation artifact for fix 103B, etc.

A build system can also analyze component dependencies between software components 402A, 402B, and 402C (e.g., published by a corresponding development groups) to determine intercomponent dependencies 218. Intercomponent dependencies 218 can describe dependencies between software components 402A, 402B, and 402C.

Method 500 includes inventorying the health of components where the plurality of code changes are to be installed (502). For example, updater 431 can issue health check 432 to cloud appliance 401. In response, updater 431 can receive health data 434. Health data 434 can indicate the health of software components 402A, 402B, 402C as well as underlying hardware, such as, for example, data center hardware components.

Method 500 includes generating an update plan for installing the plurality of code changes based on the inventoried component health, the management artifacts, and the dependencies between the plurality of code changes (503). For example, plan generator 437 can generate update plan 436 for installing update 403A, update 403B, fix 403C, etc. Update plan 436 can be based on health data 434, installation artifact references 417, and intercomponent dependencies 418. Update plan 436 can indicate a sequence for installing update 403A, update 403B, fix 403C, etc, configuration settings for update 403A, update 403B, fix 403C, etc., etc.

Method 500 includes implementing the update plan to install the plurality of code updates, including referring to the management artifacts to install the plurality of code changes in accordance with the intercomponent dependencies (504). For example, updater 431 can implement update plan 436 to install update 403A, update 403B, and fix 403C at software components 402A, 402B, and 402C respectively to update cloud appliance 401. Updater 431 can refer to installation artifacts 404A, 404B, 404C, etc. to install update 403A, update 403B, and fix 403C in accordance with intercomponent dependencies 418.

When appropriate, software update package 411 can also include payload 419. Payload 419 can contain code changes and/or installation artifacts. In one aspect, when an express reference for a code change or installation artifact is not included, updater 431 can be configured to check an external default location for the code change. In another aspect, when an express reference for a code change or installation artifact is not included, updater 431 can check payload 419.

A software update package can also refer to and/or include validation code for validating a change to one or more software components. In one aspect, validation code for validating a code change (e.g., update or fix) to a software component is included in installation artifacts (e.g., in installation artifacts 404A, 404B, 404C, etc.) for the software component. In another aspect, validation code for validating a code change to a software component is separate from installation artifacts for the software component. Validation code for a software component may or may not be maintained by the development group that maintains the software component. After a code change for a software component is implemented, the validation code can be run to validate that the code change was properly implemented.

Similar validation code can be used to validate an initial installation of a software component. After software component is installed, validation code can be run to validate that the installation was properly implemented.

A build system can also formulate additional validation code for validating that the contents of a software update package or a software installation package brought a cloud appliance to an indicated goal state. After installation of and/or code changes for individual software components are validated, the additional validation code can be run to validate that the cloud appliance was brought to a goal state. In one aspect, the additional validation code is used to validate intercomponent dependencies identified through build system analysis (and possibly not otherwise indicated by development groups).

As such, software update packages can progress through a linear progression of validated states. Since prior states are validated and a build system can track prior states, the number of different combinations and versions of software components possibly used for a cloud appliance is significantly reduced. The reduced number of states in turn reduces the complexity of progressing from a prior state to a goal state (even when software update packages corresponding to one or more intermediate states in the linear progression are not used). The reduced number of states also reduces test burden.

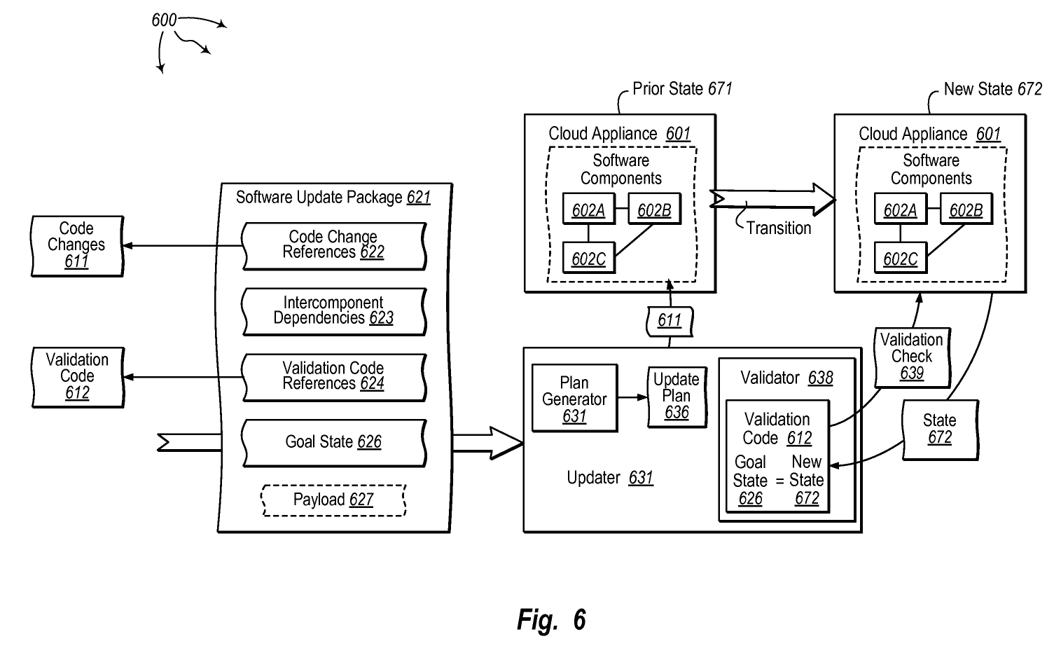

Turning to FIG. 6, FIG. 6 illustrates an example computer architecture 600 that facilitates updating a software system. Referring to FIG. 6, computer architecture 600 includes cloud appliance 601 and updater 631. Cloud appliance 601 and updater 631 can be connected to (or be part of) a network, such as, for example, a Local Area Network (“LAN”), a Wide Area Network (“WAN”), and even the Internet. Accordingly, cloud appliance 601 and updater 631 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

In general, updater 631 is configured to access a software update package and update cloud appliance 601. Updater 631 further includes plan generator 637 and validator 638. Plan generator 637 is configured to generate an update plan based on the contents of a software update package. Validator 638 is configured to validate that a software update transitioned to a goal state defined in the software update package.

Cloud appliance 601 includes interoperating software components 602A, 602B, and 602C.

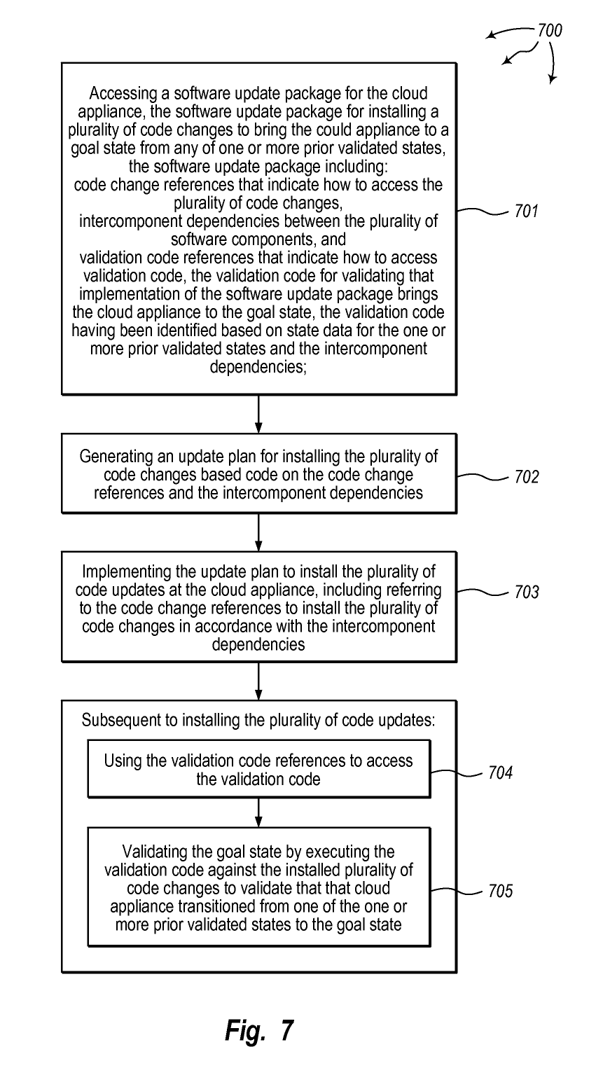

FIG. 7 illustrates a flow chart of an example method 700 for updating a software system. Method 700 will be described with respect to the components and data of computer architecture 600.

Method 700 includes accessing a software update package for the cloud appliance, the software update package for installing a plurality of code changes to bring the could appliance to a goal state from any of one or more prior validated states, the software update package including code change references that indicate how to access the plurality of code changes, intercomponent dependencies between the plurality of software components, and validation code references that indicate how to access validation code, the validation code for validating that implementation of the software update package brings the cloud appliance to the goal state, the validation code having been identified based on state data for the one or more prior validated states and the intercomponent dependencies (701).

For example, updater 631 can access software update package 621. Software update package 621 can be accessed from an update directory, an update website, a movable disk, etc. Software update package 621 includes code change references 622 (to code changes 611), intercomponent dependencies 623, validation code references 624 (to validation code 612), and goal state 626. Code change references 622 indicate how to access code changes 611. Intercomponent dependencies 623 can describe dependencies between software components 602A, 602B, and 602C. Validation code references 624 indicate how to access validation code 612 for validation that software update package 621 has transitioned cloud appliance 601 to goal state 626. Goal state 626 defines a desired outcome state for cloud appliance 601 after implementation of software update package at cloud appliance 621. An outcome state can include configuration, settings, component health, etc. at cloud appliance 601.

Method 700 includes generating an update plan for installing the plurality of code changes based on the code change references and the intercomponent dependencies (702). For example, plan generator 637 can generate update plan 636 for installing code changes 611. Update plan 636 can be based on code change references 622 and intercomponent dependencies 623. Update plan can indicate a sequence for installing update code changes 611, configuration settings for code changes 611, etc.

Method 700 includes implementing the update plan to install the plurality of code changes at the cloud appliance, including referring to the code change references to install the plurality of code updates in accordance with the intercomponent dependencies (703). For example, updater 631 can implement update plan 636 to install code changes 611 to software components 602A, 602B, 692C, etc. to update cloud appliance 601. Updating cloud appliance can cause cloud appliance 601 to transition from prior state 671 to new state 672. Prior state 671 can be a prior validated state corresponding to an earlier software update package implemented at cloud appliance 601.

Subsequent to installing the plurality of code updates, method 700 includes using the validation code references to access the validation code (704). For example, validator 638 can use validation code references 624 to access validation code 612.

Subsequent to installing the plurality of code updates, method 700 includes validating the goal state by executing the validation code against the installed plurality of code changes to validate that that cloud appliance transitioned from one of the one or more prior validated states to the goal state (705). For example, validator 638 can execute validation code 612 against code changes 611 to validate that cloud appliance 601 transitioned to goal state 626. Validation code 612 can perform validation checks 639 on cloud appliance 601 to determine that cloud appliance 601 has transitioned to new state 672. Validation code 612 can then compare goal state 626 to new state 672. If goal state 626 and new state 672 are sufficiently similar (or the same), validator 638 validates cloud appliance 601 as having successfully transitioned to goal state 626.

When appropriate, software update package 621 can also include payload 627. Payload 627 can contain code changes. In one aspect, when an express reference for a code change is not included, updater 631 can be configured to check an external default location for the code change. In another aspect, when an express reference for a code change is not included, updater 631 can check payload 627 for the code change.

Aspects of the invention (e.g., manifest design) provide software components with the flexibility of specifying the execution order. As such, an end-to-end update can be organized as multiple passes. Each software component can specify scripts/actions to be executed for a pass and a software component is allowed to span across multiple passes. Thus, one software component can configure aspects that depend on one or more other software components being fully or partially updated for success. A choreographer can use a dependency sorter to ensure that software component dependencies are honored. Passes can be executed sequentially. Execution within a pass can be serial based on software component dependency.

Accordingly, software update packages can be created for use in a multi-pass installation process. Each pass of the multi-pass process can perform a portion of the work for installing a software update and validating the software update. Installation artifacts for each software component can have code tailored to different passes in a multi-pass installation process. The tailored code can specify actions to be executed for each pass in the multi-pass installation process. In one aspect, passes in a multi-pass process including a pre-validation pass, an update pass, and a test pass.

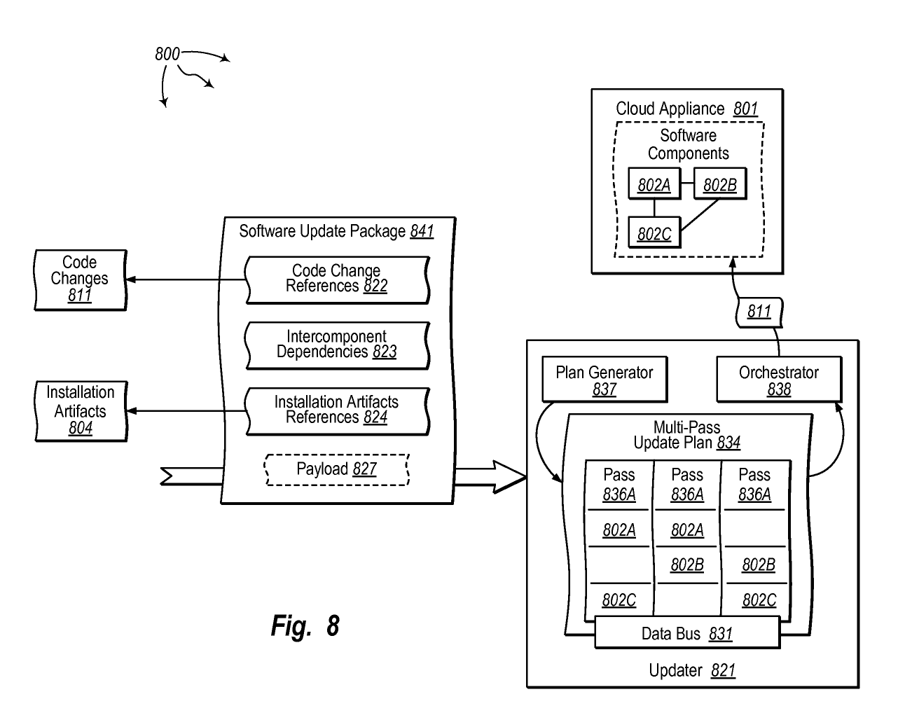

Turning to FIG. 8, FIG. 8 illustrates an example computer architecture 800 that facilitates updating a software system. Referring to FIG. 8, computer architecture 800 includes cloud appliance 801 and updater 831. Cloud appliance 801 and updater 831 can be connected to (or be part of) a network, such as, for example, a Local Area Network (“LAN”), a Wide Area Network (“WAN”), and even the Internet. Accordingly, cloud appliance 801 and updater 831 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

In general, updater 831 is configured to access a software update package and update cloud appliance 801. Updater 831 further includes multi-pass plan generator 837 and orchestrator 838. Multi-pass plan generator 837 is configured to generate an multi-pass update plan based on the contents of a software update package. Orchestrator 838 is configured to insure that intercomponent dependencies are honored during implementation of code changes for a software update package.

Cloud appliance 801 includes interoperating software components 802A, 802B, and 802C.

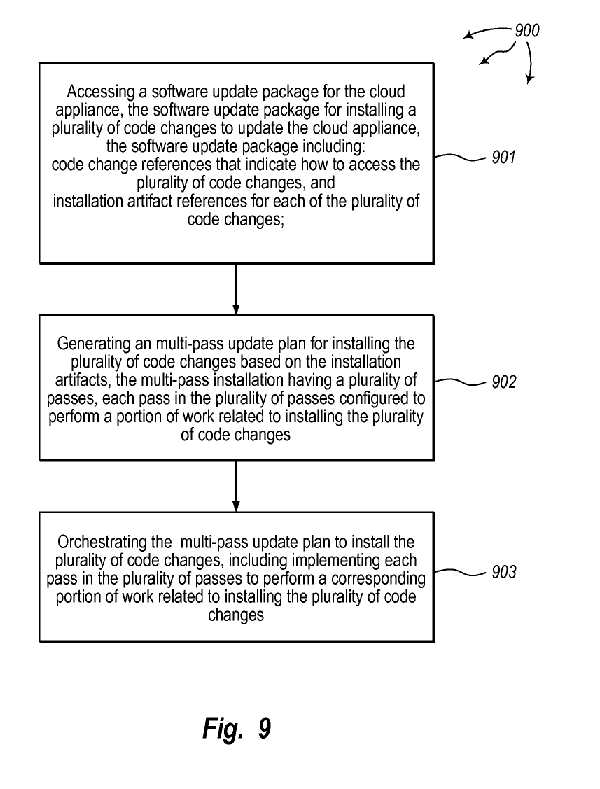

FIG. 9 illustrates a flow chart of an example method 900 for updating a software system. Method 900 will be described with respect to the components and data of computer architecture 800.

Method 900 includes accessing a software update package for the cloud appliance, the software update package for installing a plurality of code changes to update the cloud appliance, the software update package including code change references that indicate how to access the plurality of code changes and installation artifact references for each of the plurality of code change (901). For example, updater 821 can access software update package 841. Software update package 841 can be accessed from an update directory, an update website, a movable disk, etc. Software update package 841 includes code change references 822 (code changes 811), intercomponent dependencies 823 (between software components 802A, 802B, 802C, etc.), and installation artifact references 824 (to installation artifacts 804).

Method 900 includes generating a multi-pass update plan for installing the plurality of code changes based on the installation artifacts, the multi-pass installation having a plurality of passes, each pass in the plurality of passes configured to perform a portion of work related to installing the plurality of code changes (902). For example, plan generator 837 can generate multi-pass update plan 836 for installing code changes 811 based on installation artifacts 804. Multi-pass update plan 836 includes passes 836A (e.g., pre-validation), 836B (e.g., update), and 836C (e.g., testing). Each of passes 836A, 836B, and 836C is configured to perform a portion of work related to installing code changes 811.

As depicted, pass 836A is configured to perform one or more portions of work with respect to code changes applicable to software components 802A and 802C. Pass 836B is configured to perform one or more portions of work with respect to code changes applicable to software components 802A and 802B. Pass 836C is configured to perform one or more portions of work with respect to code changes applicable to software components 802B and 802C.

Method 900 includes orchestrating the multi-pass update plan to install the plurality of code changes, including implementing each pass in the plurality of passes to perform a corresponding portion of work related to installing the plurality of code changes (903). For example, orchestrator 838 can orchestrate multi-pass update plan 836 to install code changes 811. Orchestrating multi-pass update plan 836 includes implementing each of passes 836A, 836B, and 836C to perform corresponding work related to installing code changes 811. Orchestrator 838 can insure that intercomponent dependencies 823 are honored during orchestration of multi-pass update plan 836.

During orchestration of multi-pass update plan 836, data bus 831 can be used to pass information between scripts/executables run in different passes. For example, dynamic (typeless) data can be passed on data bus 831. Each of software components 802A, 802B, and 802C can be provided with a namespace and is allowed to read data from and/or write data databus 831. Databus 831 facilitates reuse of scripts/data between software components 802A, 802B, and 802C and use of multiple smaller scripts instead of one larger (e.g., monolithic, do-it-all) script.

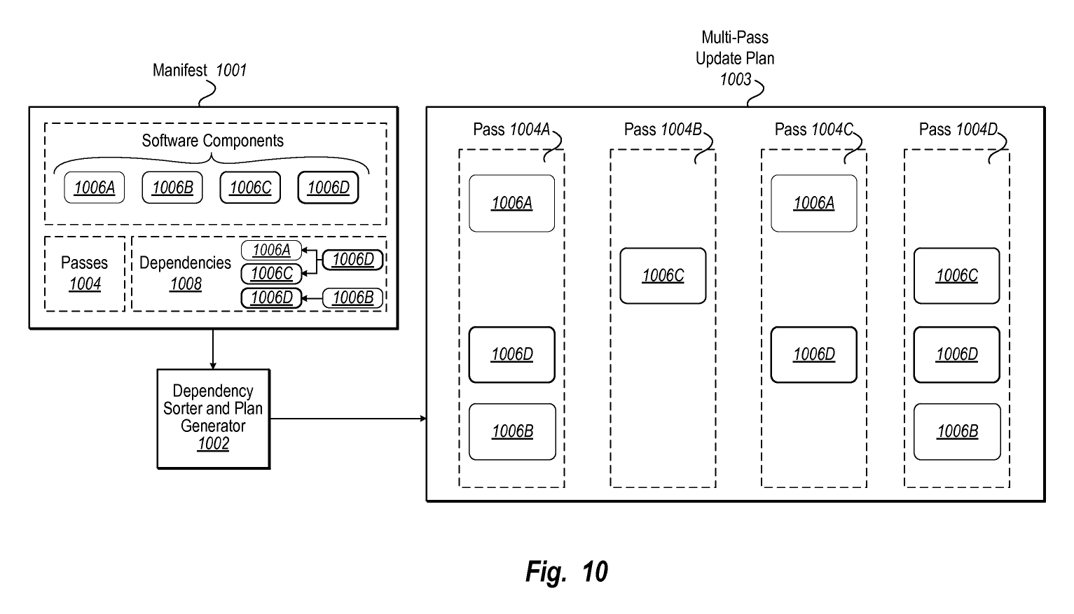

In one aspect, a manifest defines the passes of a multi-pass installation process. FIG. 10 illustrates an example of processing a manifest 1001 to create a multi-pass installation plan 1003. As depicted, manifest 1001 indicates code changes for software components 1006A, 1006B, 1006C, and 1006D. Manifest 1001 also defines passes 1004 and intercomponent dependencies 1008. As depicted, software component 1006D depends on software component 1006B and software components 1006A and 1006C depend on software component 1006D.

Dependency sorter and plan generator 1002 accesses manifest 1001 and creates multi-pass installation plan 1003. Multi-pass installation plan 1003 includes passes 1004A, 1004B, 1004C, and 1004D. Work related to software components 1006A, 1006D, and 1006B is performed in pass 1004. Work related to software component 1006C is performed in pass 1004B. Work for software components 1006A and 1006D is performed in pass 1004C. Work for software components 1006C, 1006D, and 1006B are performed in pass 1004D.

In one aspect, updater 821 includes the functionality of dependency sorter and plan generator 1002 and process manifests to generate multi-pass update plans.

Any of the described aspects of the invention can also work in combination to install and update software systems. For example, an updater can process a software update package that includes a version, a bill or materials (BOM), and a manifest, wherein validation code references are included in the manifest. Alternately, an updater create a multi-pass installation plan, wherein a pass of the multi-pass installation plan includes validation.

In some aspects, an overall flow for updating a cloud appliance is as follows:
(A) Check if cloud appliance is already at an appropriate version, if so end update
(B) Run a health check on the cloud appliance to verify cloud appliance his healthy
(C) Download and aggregate one or more updates and approve them for installation
(D) Run an inventory tool to record pre-update status
(E) For each individual software component update the software component
(F) Run inventory tool to record post-update status
(G) Generate overall compliance report.

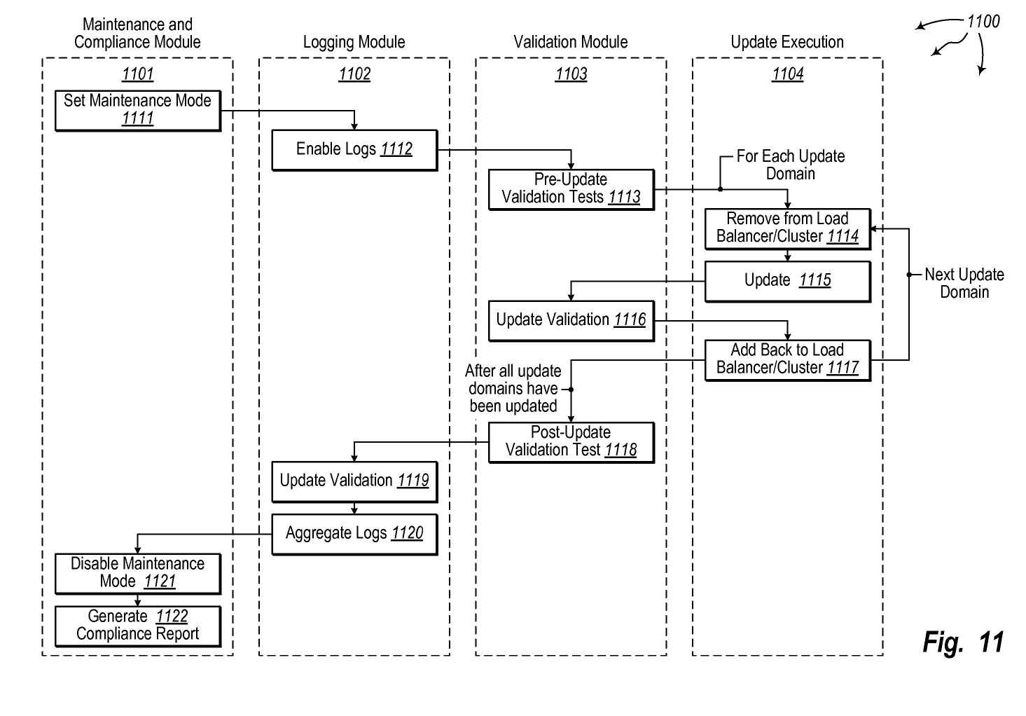

FIG. 11 illustrates a flow chart of an example method 1100 of updating an individual software component (element (E) from the overall flow). A maintenance and compliance module 1101 sets the software component to maintenance mode (1111). A logging module 1102 enables logs for the software component (1112). A validation module 1103 runs pre-update validation tests on the software component (1113).

During update execution 1104, for each update domain, the update domain is removed from a load balance/cluster (1114) and updated (1115). The validation module 1103 validates the update to the domain (1116). During update execution 1104, the updated domain is added back into the load balancer/cluster (1117).

After all update domains are updated, the validation module 1103 rungs post-update validation tests (1118). Logging module 1102 disables logs (1119) and aggregates logs (1120). Maintenance and compliance module 1101 disables maintenance mode (1121) and generates a compliance report (1122).

Software update packages can be created from various different combinations of developer provided data.

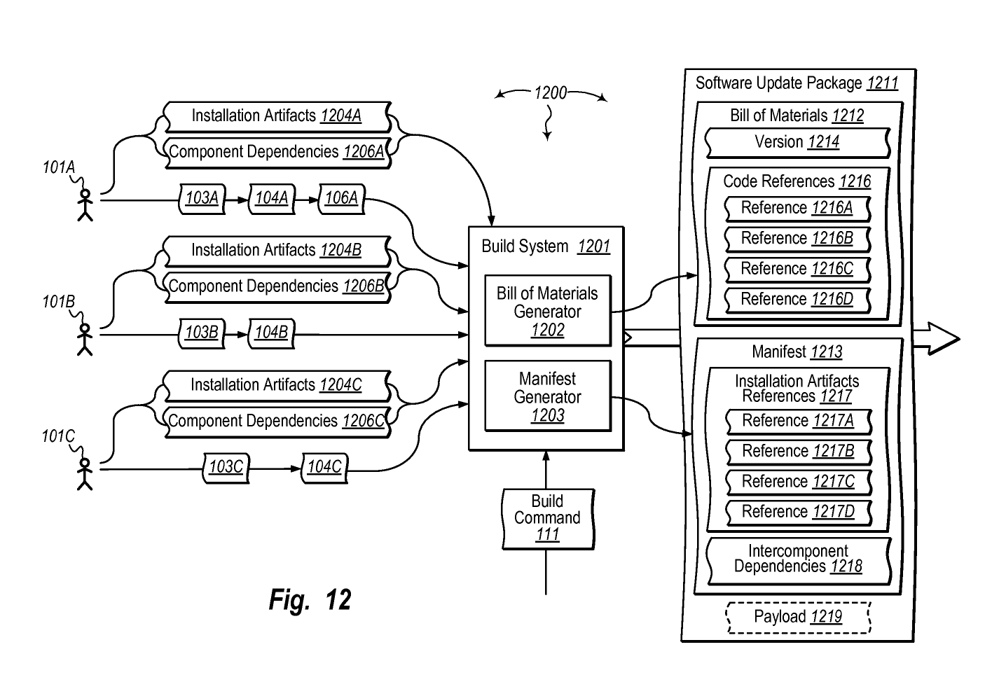

FIG. 12 illustrates an example computer architecture 1200 that facilitates creating a software update package. Referring to FIG. 12, computer architecture 1200 includes build system 1201. Build system 1201 can be connected to (or be part of) a network, such as, for example, a Local Area Network (“LAN”), a Wide Area Network (“WAN”), and even the Internet. Accordingly, build system 1201 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

As depicted, build system 1201 further includes bill of materials generator 1202 and manifest generator 1203. In general, Bill of materials generator 1202 is configured to generate Bills of Material (BOM) for inclusion in a software update package. Similarly, manifest generator 1203 is configured to generate a manifest for inclusion in a software update package.

Bill of materials generator 1202 can generate a list of changes that are to be applied to take a software system (e.g., a cloud appliance) to a next version. To facilitate single-click upgrades, a Bill of Materials (BOM) is designed to be cumulative. During a build process, bill of materials generator 1202 scans accessed changes (e.g., updates and fixes) to automatically generate a list of updates that are to be applied.

Along with code changes for a software component, a development group can also make installation artifacts (e.g., installation artifacts 1204A, 1204B, 1204C) and component dependencies (e.g., component dependencies 1206A, 1206B, 1206C) for the software component available to build system 1201.

Manifest generator 1203 can generate a manifest that includes a list of installation artifacts (e.g., installation scripts) used to install the listed updates in a BOM and that describes intercomponent dependencies between software components. During a build process, manifest generator 1203 scans provided installation artifacts and component dependencies. Manifest generator 1203 can use the provided installation artifacts to generate the list of installation artifacts for installing the listed updates. Manifest generator 1203 can also analyze provided component dependencies to identify intercomponent dependencies.

Referring intermittently between FIGS. 1 and 12, in response to build command 111, build system 1201 can gather update 103A, fix 104A, fix 106A, fix 103B, update 104B, fix 103C, and update 104C for updating a cloud appliance that includes software components 102A, 102B, and 102C.

Build system 1201 can create software update package 1211. Software update package 211 can be used for installing update 103A, fix 104A, fix 106A, fix 103B, update 104B, fix 103C, and update 104C to bring a cloud appliance that includes software components 102A, 102B, and 102C to a goal state.

Creating a software package for a cloud appliance can include formulating a bill of materials (BOM) for a software update package version. The software update package version can be the next version in a linear progression of a plurality of software update package versions for updating the cloud appliance. One or more prior versions in the linear progression can correspond to the one or more prior states. For example, bill of materials generator 1202 can formulate bill of materials (BOM) 1212. Bill of materials 1212 includes version 1214 and code references 1216. Version 1214 can be the next version in a linear progression of software update package versions for updating a cloud appliance that includes software components 102A, 102B, and 102C.

As such, build system 1201 may have previously created other software update packages for updating a cloud appliance that includes software components 102A, 102B, and 102C. For example, build system 1201 may have previously created a software update package based on update 103A and fix 103C shortly after t₁. When installed, this previous software update package would bring a cloud appliance that includes software components 102A, 102B, and 102C to one of the one or more prior states.

Bill of materials generator 1202 can scan update 103A, fix 104A, fix 106A, fix 103B, update 104B, fix 103C, and update 104C to automatically generate code references 1216. Code references 1216 include references for accessing code changes. For example, reference 1216A can correspond to a location for update 103A, reference 1216B can correspond to a location for fix 104A, reference 1216C can correspond to a location for fix 106A, reference 1216D can correspond to a location for fix 103B, etc. In one aspect, when an express reference for a code change is not included, an installation system can be configured to check an external default location for the code change. In another aspect, when an express reference for a code change is not included, an installation system can check a payload attached to a software update package.

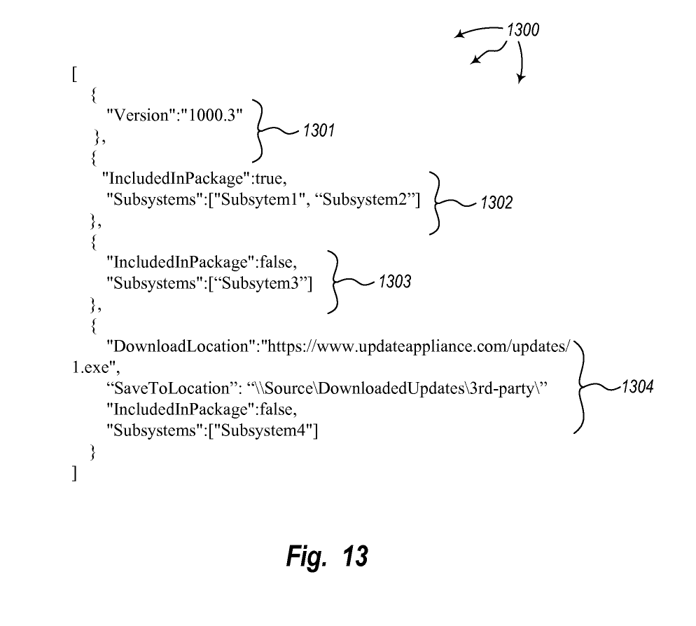

Turning briefly to FIG. 13, FIG. 13 illustrates an example of a Bill of Materials (BOM) 1300 for a software update package. Within BOM 1300, block 1301 indicates a version for BOM 1300. Block 1302 indicates that code changes for “subsystem1” and “subsystem2” are included in the software update package containing BOM 1300. Block 1303 indicates that code changes for “subsystem3” are not included in the software update package containing BOM 1300. Since no other express reference is indicated, an installation system can check an external default location (e.g., an update Web site) for code changes for subsystem3. Block 1304 indicates that code changes for “subsystem4” are not in an attached payload. An express reference indicates that code changes for Subsystem4 can be downloaded from “https://www.updateappliance.com/updates/1.exe” and saved to “\\Source\DownloadedUpdates\3rd-party\”.

Returning back to FIGS. 1 and 12, creating a software package from the cloud appliance can include formulating a manifest. The manifest can include references to management artifacts for installing the plurality of code changes and indicates interdependencies between code changes from among the plurality of code changes. For example, manifest generator 1203 can formulate manifest 1213. Manifest 1213 includes installation artifact references 1217 and intercomponent dependencies 1218.

Manifest generator 1213 can scan installation artifacts 1204A, 1204B, and 1204C to generate installation artifact references 1217. Each reference in installation artifact references 1217 can refer to an installation artifact for a corresponding code change. For example, reference 1217A can refer to an installation artifact for update 103A, reference 1217B can refer to an installation artifact for fix 104A, reference 1217C can refer to an installation artifact for fix 106A, reference 1217D can refer to an installation artifact for fix 103B, etc.

Manifest generator 1213 can also analyze component dependencies 1206A, 1206B, and 1206C to determine intercomponent dependencies 218. Intercomponent dependencies 218 can describe dependencies between software components 102A, 102B, and 102C.

Creating a software package for a cloud appliance can also include including the bill or materials and the manifest in the software update package. For example, build system 1201 can include bill of materials (BOM) 212 and manifest 1213 in software update package 1211.

When appropriate, build system 1201 can also include payload 1219 in software update package 1212. Payload 1219 can include code changes, such as, for example, one or more of: 103A, fix 104A, fix 106A, fix 103B, update 104B, fix 103C, and update 104C.

A software update package can be made available so that entities running the cloud appliance can update the cloud appliance to the goal state from any of the one or more prior states For example, build system 1201 can store software update package 1211 in a known location for software updates. A known location can include, for example, an update directory, an update website, a movable disk, etc.

In one aspect, a build system generates a corresponding software installation package along with a software update package in response to a build command. The software installation package can be used to install instances of cloud appliance on hardware. The software update package can be used update instances of cloud appliance that are already installed on hardware. Both the software installation package and the software update package are configured to bring a cloud appliance to essentially the same goal state.

Referring briefly to FIG. 4, software update package 411 can be a software update package generated in a manner similar to software update package 1211.

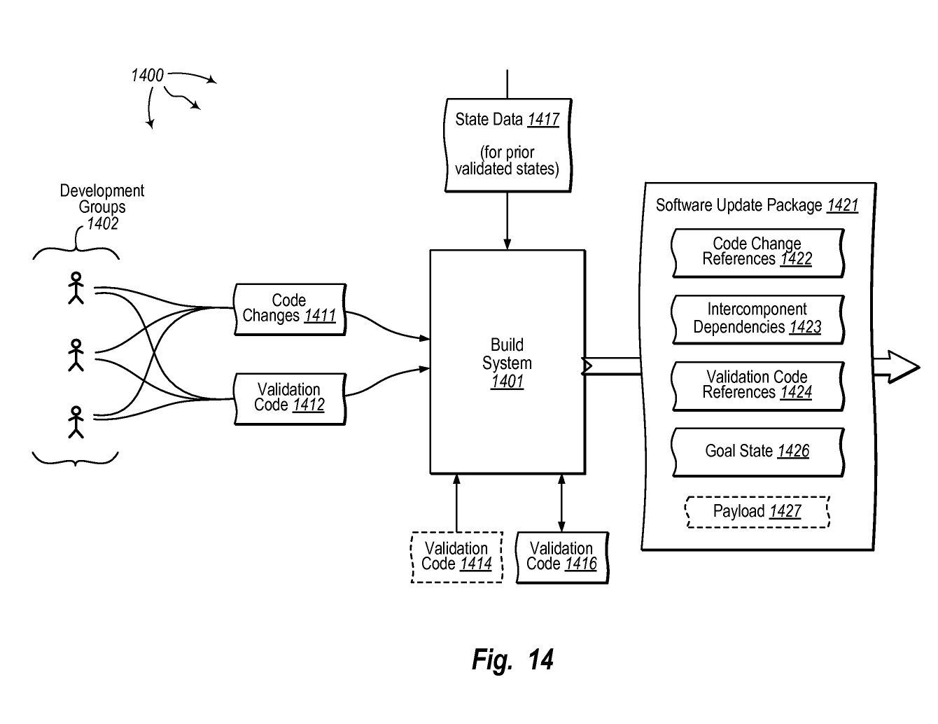

Turning to FIG. 14, FIG. 14 illustrates an example computer architecture 1400 that facilitates creating a software update package for linear progression between validated goal states. Referring to FIG. 14, computer architecture 1400 includes build system 1401. Build system 1401 can be connected to (or be part of) a network, such as, for example, a Local Area Network (“LAN”), a Wide Area Network (“WAN”), and even the Internet. Accordingly, build system 701 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

In general, build system 1401 can build a software update package for validating progression of a cloud appliance to a goal state. Build system 1401 is configured to access code changes (e.g., updates and/or fixes) from development groups for software components used in a cloud appliance. Build system 1401 is also configured to access validation code for validating proper implementation of accessed code changes. Build system 1401 is also configured to access state data for one or more prior validated states for the cloud appliance. The cloud service linearly can have progressed through the one or more prior validated states by implementing previously built software update packages to update the cloud appliance. From the accessed code changes, the accessed validation code, and the accessed state data, build system 1401 can build a software update package for validating linear progression of the software appliance from any of the one or more prior validated states to the goal state.

A plurality of code changes can be gather for updating a cloud appliance, the plurality of code changes including one or more code changes for each of a plurality of software components, the one or more code changes for each software component having been released by a managing development group for the software component. For example, build system 1401 can gather code changes 1411 from development groups 1402. Each of development groups 1402 can manage a software component to be updated at a cloud appliance.

Build system 1401 can create software update package 1421. Software update package 1421 can be for implementing code changes 711 at a cloud appliance to bring the cloud appliance to goal state 726 from any of one or more prior validated states.

Creating a software update package for a cloud appliance can include identifying code change references that indicate how to access the plurality of code changes. For example, build system 1401 can identify code change references that indicate how to access code changes 1411. Creating a software update package for the cloud appliance can also include analyzing the plurality of code changes to identify intercomponent dependencies between the plurality of software components For example, build system 1401 can analyze code changes 1411 (possible along with other developer provider information) to identify intercomponent dependencies 1423 between software components managed by development groups 1402.

Creating a software update package for the cloud appliance can include accessing state data for the one or more prior validated states. For example, build system 1401 can access state data 1417. State data 1417 can be for one or more prior validated states of the cloud appliance.

Creating a software update package for the cloud appliance can include identifying validation code for validating that implementation of the software update package brings the cloud appliance to the goal state, the validation code identified based on the accessed state data and identified intercomponent dependencies. For example, build system 1401 identify relevant portions of one or more of: validation code 1417 (provided by development groups 1402) and validation code 1414 (provided or from other sources) based on state data 1417 and intercomponent dependencies 1423. Identified portions of validation code can be used to validate that software update package 1421 brings a cloud appliance to goal state 1426.

Build system 1401 can also manage validation code 1416. When build system 1401 detects that other validation code is insufficient for validating a software update package, build system 1401 can create or modify validation code 1416 to supplement the other validation code.

Creating a software update package for the cloud appliance can include formulating validation code references referring to the identified validation code. For example, build system 1401 can formulate validation code references 1424 referring to identified portions of one or more of: validation code 1412, validation code 1414, and validation code 1416.

Creating a software update package for the cloud appliance can include including the code change references, intercomponent dependencies, validation code references, and the goal state in the software update package. For example, build system 1401 can include code change references 1432, intercomponent dependencies 1423, validation code references 1424, and goal state 1426 in software update package 1431. When appropriate, build system 1401 can also include payload 1427 in software update package 1421. Payload 1427 can contain code changes and/or validation code.

The software update package can be made available so that entities running the cloud appliance can validate that implementation of the software update package brings the cloud appliance to the goal state from any of the one or more prior validated states. For example, build system 1401 can store software update package 1421 in a known location for software updates. A known location can include, for example, an update directory, an update website, a movable disk, etc.

Similar methods can also be used to create a software installation package.

Referring briefly to FIG. 6, software update package 621 can be a software update package generated in a manner similar to software update package 1421.

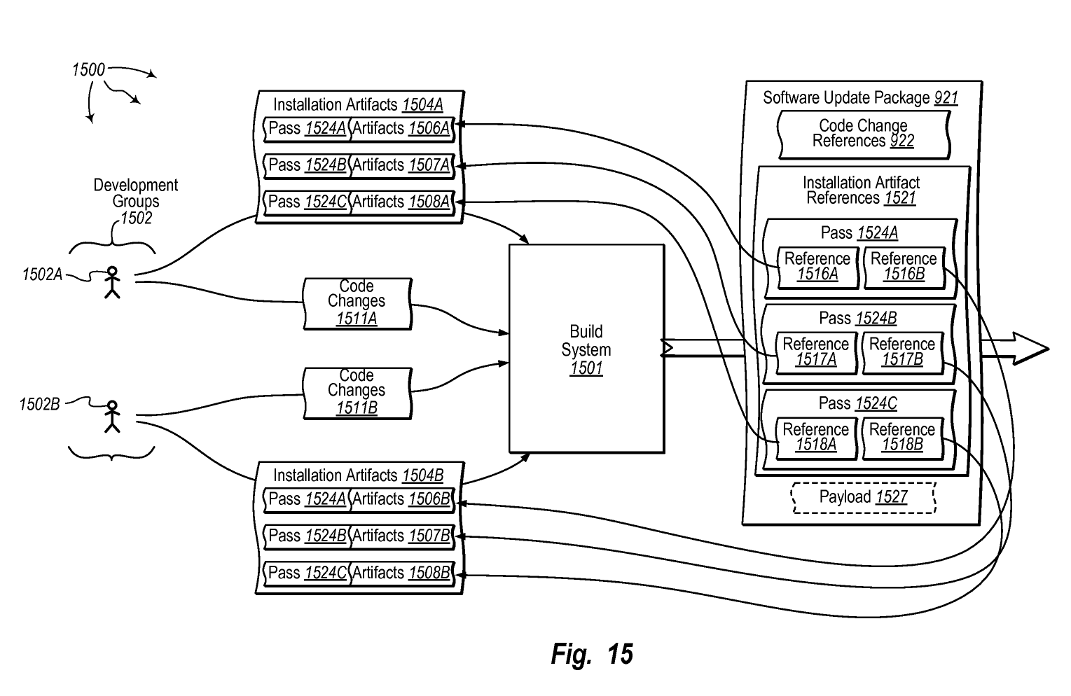

Turning to FIG. 15, FIG. 15 illustrates an example computer architecture 1500 that facilitates creating a software update package for use in a multi-pass installation. Referring to FIG. 15, computer architecture 1500 includes build system 1501. Build system 1501 can be connected to (or be part of) a network, such as, for example, a Local Area Network (“LAN”), a Wide Area Network (“WAN”), and even the Internet. Accordingly, build system 1501 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

In general, build system 1501 can build a software update package for use in a multi-pass installation. Build system 1501 is configured to access code changes (e.g., updates and/or fixes) from development groups for software components used in a cloud appliance. Build system 1501 is also configured to access installation artifacts for installing accessed code changes. Build system 1501 can identify installation artifacts tailored to a specified pass in the multi-pass installation. Build system 1501 can group installation artifact references tailored for a specified pass together in a software update. From the accessed code changes and access installation artifacts, build system 1501 can build a software update package for use in a multi-pass installation.

A plurality of code changes can be gathered for updating a cloud appliance, the plurality of code changes including one or more code changes for each of the plurality of software components, the one or more code changes for each software component having been released by a managing development group for the software component. For example, build system 1501 can gather code changes 1511A and code changes 1511B form development groups 1502A and 1502B respectively. Each of development groups 1502A and 1502B can manage a software component to be updated at a cloud appliance.

A software update package can be created for the cloud appliance, the software update package for installing the plurality of code changes through the multi-pass installation process. For example, build system 1501 can create software update package 1521 for the cloud appliance. Software update package 1521 can be for implementing code changes 1511A and 1511B at the cloud appliance through a multi-pass installation process. The multi-pass installation process can include three passes, pass 1524A (e.g., pre-validation), pass 1524B (e.g., update), and pass 1524C (e.g., testing).

Creating a software package can include identifying code change references that indicate how to access the plurality of code changes. For example, build system 1501 can identify code change references 1522 that indicate how to access code changes 1511A and 1511B. Creating a software package can include identifying installation artifacts for each of the plurality of code changes. For example, build system 1501 can identify installation artifacts 1504A and 1504B for code changes 1511A and 1511B respectively.

Creating a software package can include for each pass in the plurality of passes and for the identified installation artifacts for each of the plurality of code changes, identifying a subset of installation artifacts tailored for the pass. For example, build system 1501 can identify artifacts 1506A and 1506B tailored to pass 1524A. Similarly, build system 1501 can identify artifacts 1507A and 1507B tailored to pass 1524B. Likewise, build system 1501 can identify artifacts 1508A and 1508B tailored to pass 1524C.

Creating a software package can include determining installation artifact references for the identified installation artifacts. For example, build system 1501 can identify installation artifact references 1524 for installation artifacts 1504A and 1504B. More specifically, build system 1501 can identity reference 1516A for artifacts 1506A, can identify identity reference 1517A for artifacts 1507A, can identity reference 1518A for artifacts 1508A, can identity reference 1516B for artifacts 1506B, can identify identity reference 1517B for artifacts 1507B, and can identity reference 1518B for artifacts 1508B.

Creating a software package can include including the code change references and the installation artifact references in the software update package. For example, build system 1501 can include code change references and installation artifact references in software update package 1521. When appropriate, build system 1501 can also include payload 1527 in software update package 1521. Payload 1527 can contain code changes and/or installation artifacts.

Including installation artifact references in the software update package can include for each pass in the plurality of passes, expressly indicating in the software update package that installation artifact references for subsets of installation artifacts tailored for the pass are to processed during the pass. For example, build system 1501 can indicate that references 1516A and 1516B are to be processed during pass 1524A. Similarly, build system 1501 can indicate that references 1517A and 1517B are to be processed during pass 1524B. Likewise, build system 1501 can indicate that references 1518A and 1518B are to be processed during pass 1524C.

The software update package can be made available so that entities running the cloud appliance can use multi-pass installation process to implement the software update package. For example, build system 1501 can store software update package 1521 in a known location for software updates. A known location can include, for example, an update directory, an update website, a movable disk, etc.

Methods similar to method 1500 can also be used to create a software installation package.

Referring briefly to FIG. 8, software update package 841 can be a software update package generated in a manner similar to software update package 1421. For example, different subsets of installation artifact references 824 can be indicated for processing in different passes of multi-pass update plan 836.

As described, a plurality of development groups can be changing code for a plurality at different software components included in a cloud appliance. Each development group can change code at a different pace. Aspects of the invention significantly reduce the complexity of updating instances of the cloud appliance with code changes and the potential for code divergence between different instances of a cloud appliance. In one aspect, a single click update is made available to entities running instances of the cloud appliance. The entities can select the update to automatically have a plurality of code changes to a plurality of different software components installed to update the cloud appliance.

The present invention may be implemented in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method for updating a cloud appliance, the cloud appliance running a plurality of different software components, at least some of the plurality of software components interoperating with one another, each of the plurality of software applications maintained by a different corresponding development group, the method comprising:
accessing a software update package, the software update package including a bill of materials (BOM) and a manifest,
the bill of materials (BOM) indicating a software package version, the software package version included in a linear progression of a plurality of software update package versions for the cloud appliance, the software package version being later in the linear progression than a prior software update package version used to update the cloud appliance, the bill of materials (BOM) indicating applicability to the cloud appliance and including references for accessing a plurality of code changes applicable to the plurality of different software components,
the manifest including:
references to management artifacts for installing the plurality of code changes; and
intercomponent dependencies between the plurality of software components; and
inventorying the health of components where the code changes are to be installed;
generating an update plan for installing the plurality of code changes based on the inventoried component health, the management artifacts, and the intercomponent dependencies; and
implementing the update plan to install the plurality of code changes on the components, including referring to the management artifacts to install the plurality of code changes in accordance with the intercomponent dependencies.

2. The method of claim 1, wherein the manifest further comprises references to validation code for validating installation of the plurality of code changes.

3. The method of claim 2, further comprising running the validation code subsequent to implementing the update plan to validate the cloud appliance reached the goal state.

4. The method of claim 1, wherein references for accessing a plurality of code changes comprises a reference to a location on the Internet.

5. The method of claim 1, wherein the software update package further include a payload, the payload containing a management artifact; and
wherein references to management artifacts include a reference to the payload.

6. The method of claim 1, wherein accessing a software update package comprises access the software update package from a publicly accessible network location.

7. The method of claim 1, wherein accessing a software update package comprises access the software update package from a moveable drive.

8. The method of claim 1, wherein generating an update plan for installing the plurality of code changes comprises generating a multi-pass installation plan for installing the plurality of code changes.

9. A method for updating a cloud appliance, the cloud appliance running a plurality of different software components, at least some of the plurality of software components interoperating with one another, each of the plurality of software applications maintained by a different corresponding development group, the method comprising:
accessing a software update package for the cloud appliance, the software update package for installing a plurality of code changes to bring the could appliance to a goal state from any of one or more prior validated states, the software update package including:
code change references that indicate how to access the plurality of code changes,
intercomponent dependencies between the plurality of software components, and
validation code references that indicate how to access validation code, the validation code for validating that implementation of the software update package brings the cloud appliance to the goal state, the validation code having been identified based on state data for the one or more prior validated states and the intercomponent dependencies;
generating an update plan for installing the plurality of code changes based code on the code change references and the intercomponent dependencies;
implementing the update plan to install the plurality of code updates at the cloud appliance, including referring to the code change references to install the plurality of code changes in accordance with the intercomponent dependencies; and
subsequent to installing the plurality of code updates:
using the validation code references to access the validation code; and
validating the goal state by executing the validation code against the installed plurality of code changes to validate that that cloud appliance transitioned from one of the one or more prior validated states to the goal state.

10. The method of claim 9, wherein using the validation code references to access the validation code comprises using the validation code references to access validation code provided by a development group for one of the plurality of software components.

11. The method of claim 9, wherein validating the goal state comprises executing validation code provided by a third party against the installed plurality of changes.

12. The method of claim 9, wherein validating the goal state comprises executing validation code created by a build system that created the software update package.

13. The method of claim further comprising, prior to validating the goal state by executing the validation code against the installed plurality of code changes, accessing the validation code from a payload attached to the software update package.

14. The method of claim 9, wherein validating the goal state comprises executing validation code during a specified pass of a multi-pass installation process.

15. A method for updating a cloud appliance, the cloud appliance running a plurality of different software components, at least some of the plurality of software components interoperating with one another, each of the plurality of software applications maintained by a different corresponding development group, the method comprising:
accessing a software update package for the cloud appliance, the software update package for installing a plurality of code changes to update the cloud appliance, the software update package including:
code change references that indicate how to access the plurality of code changes, and
installation artifact references for each of the plurality of code changes;
generating a multi-pass update plan for installing the plurality of code updates based on the installation artifacts, the multi-pass installation having a plurality of passes, each pass in the plurality of passes configured to perform a portion of work related to installing the plurality of code changes; and
orchestrating the multi-pass update plan to install the plurality of code updates, including implementing each pass in the plurality of passes to perform a corresponding portion of work related to installing the plurality of code changes.

16. The method of claim 15, wherein accessing a software update package for the cloud appliance comprises accessing a software update package that expressly indicates different subsets of the installation artifacts are tailored for processing during different passes from among the plurality of passes.

17. The method of claim 15, wherein installation artifacts being included in the software update package comprises the installation artifacts being included in a manifest.

18. The method of claim 15, further comprising:
accessing validation code for validating installation of the plurality of code changes; and
running the validation code during a specified pass defined in the multi-pass update plan to validate that the plurality of code changes transitioned the software component to a desired goal state.

19. The method of claim 15, wherein generating a multi-pass update plan comprises generating a multi-pass update plan that includes a pre-validation pass, an update pass, and a testing pass.

20. The method of claim 15, wherein orchestrating the multi-pass update plan to install the plurality of code updates comprises orchestrating the multi-pass update plan to install the plurality of code updates in accordance with intercomponent dependencies between the plurality of software components.
